(19) United States
(12) Patent Application Publication
(10) Pub. No.: US 2026/0218406 A1
(43) Pub. Date: Jul. 30, 2026

(54) COMPOSITE MATERIAL, COMPOSITE MATERIAL MANUFACTURING METHOD, TERMINAL, AND TERMINAL MANUFACTURING METHOD

(71) Applicant: DOWA METALTECH CO., LTD., Tokyo (JP)

(72) Inventors: Kodai KIWAKI, Tokyo (JP); Akira SUGAWARA, Tokyo (JP); Takao TOMIYA, Tokyo (JP); Hirotaka TAKAHASHI, Tokyo (JP)

(73) Assignee: DOWA METALTECH CO., LTD., Tokyo (JP)

(21) Appl. No.: 19/149,199

(22) PCT Filed: Mar. 11, 2024
(86) PCT No.: PCT/JP2024/009270

§ 371 Date: Jul. 18, 2025

(30) Foreign Application Priority Data
Mar. 13, 2023 (JP) 2023-039015
Mar. 6, 2024 (JP) 2024-033609

(51) Int. Cl. C25D 3/46; H01B 1/16

(52) U.S. Cl. CPC C25D 3/46; H01B 1/16

(57) ABSTRACT

There is provided a composite material having a composite coating on a base material, the composite coating being composed of a silver layer containing metal sulfide particles, wherein a value X obtained by dividing arithmetic mean roughness Ra (μm) of the composite coating by a thickness (μm) of the composite coating is 0.14 or less.

### TECHNICAL FIELD

The present invention relates to a composite material having a predetermined composite coating on a base material, and a manufacturing method thereof, and particularly to a composite material used as a material for sliding contact parts such as switches and connectors, and a manufacturing method thereof.

### DESCRIPTION OF RELATED ART

Conventionally, as a material for sliding electrical contact parts such as switches and connectors, a silver (Ag)-plated material has been used in which a conductive base material such as Cu (copper) and a Cu alloy is plated with silver to prevent oxidation of the conductive material due to heating during a sliding process.

However, silver plating is soft and easily worn, and generally has a high coefficient of friction, so there is a problem that it easily peels off due to sliding. To solve this problem, a method has been proposed to increase wear resistance by forming a coating of a composite material on a conductive base material by electroplating, that is a composite material in which graphite particles, among carbon particles such as graphite and carbon black having excellent wear resistance and lubricity, are dispersed in a silver matrix (for example, see Patent documents 1 to 3). According to Patent document 3, there is a general description such that in addition to carbon particles, particles composed of molybdenum disulfide, tungsten disulfide, boron nitride, or graphite fluoride are also effective in increasing wear resistance.

According to Patent document 4, another highly wear-resistant composite material is a terminal material for connectors, in which an antimony-containing silver plating layer having an average crystal grain size of 0.1 μm or more and 2.0 μm or less is formed on a base material at least whose surface is composed of copper or a copper alloy.

According to Patent document 5, further more highly wear-resistant composite material is a composite material in which a composite coating composed of a silver layer containing carbon particles is formed on a base material, with a crystallite size of silver in the composite coating being 40 nm or less.

### PRIOR ART DOCUMENT

Patent document
[Patent Document 1] JP H9-7445 A
[Patent Document 2] JP 2007-16250 A
[Patent Document 3] Japanese Patent No. 2018-1023347 A
[Patent Document 4] Japanese Patent No. 2020-105551 A
[Patent Document 5] International Publication No. 2021/261066

### SUMMARY OF THE INVENTION

### Problem to be Solved by the Invention

However, in the composite material disclosed in Patent document 5, many nodular electrodeposition structures considered to be composed of silver are generated on the surface of the composite coating. These nodules are weakly bonded to a surrounding tissue (the silver matrix that constitutes the composite coating) and can easily fall off due to external stress, so there may be a risk of contaminating the equipment during use of the composite material by a user (during bending, etc.).

The present invention has been made under the above circumstances, and an object of the present invention is to provide a composite material having sufficient wear resistance for practical use and suppressing silver shedding from a composite coating during bending, and a manufacturing method for the composite material.

### Means for Solving the Problem

As a result of intensive research by the present inventors to solve the above problem, it is found that when electroplating a base material using a silver plating solution containing metal sulfide particles, a composite coating is formed, with suppressed generation of nodules and having few protrusions, and by using a composite material having such a composite coating, the above problem can be solved. Thus, the present invention is completed.

That is, the present invention is as follows.

[1] A composite material having a composite coating on a base material, the composite coating being composed of a silver layer containing metal sulfide particles, wherein a value X obtained by dividing arithmetic mean roughness Ra (μm) of the composite coating by a thickness (μm) of the composite coating is 0.14 or less.

[2] The composite material according to [1], wherein metal sulfide constituting the metal sulfide particles is at least one selected from the group consisting of molybdenum sulfide, tungsten sulfide, and tin sulfide.

[3] The composite material according to [1] or [2], wherein a crystallite size of silver in the composite coating is 62 nm or less.

[4] The composite material according to any one of [1] to [3], wherein a mass ratio of the metal sulfide particles on a surface of the composite coating, which is obtained by measuring the surface of the composite coating by energy dispersive X-ray analysis, is 1 to 50 mass %.

[5] The composite material according to any one of [1] to [4], wherein the base material is composed of copper or a copper alloy.

[6] The composite material according to any one of [1] to [5], wherein the metal sulfide constituting the metal sulfide particles is at least one selected from the group consisting of MoS₂ and WS₂.

[7] The composite material according to any one of [1] to [6], wherein a thickness of the composite coating is 0.5 to 45 μm.

[8] The composite material according to any one of [1] to [7], wherein a content of the metal sulfide particles in the composite coating is 0.5 to 30 mass %.

[9] The composite material according to any one of [1] to [8], wherein a crystallite size of silver in the composite coating is 62 nm or less, and the value X is 0.088 or less.

[10] The composite material according to any one of [1] to [9], wherein a content of the metal sulfide particles in the composite coating is 2.5 to 10 mass %, and the metal sulfide constituting the metal sulfide particles is molybdenum sulfide.

[11] A composite material manufacturing method, including: performing electroplating in a silver plating solution containing metal sulfide particles, thereby forming a composite coating on a base material, the composite coating being composed of a silver layer containing the metal sulfide particles.

[12] The composite material manufacturing method according to [11], wherein the base material is composed of copper or a copper alloy.

[13] The composite material manufacturing method according to or [12], wherein the silver plating solution contains compound A represented by the following general formula (I):

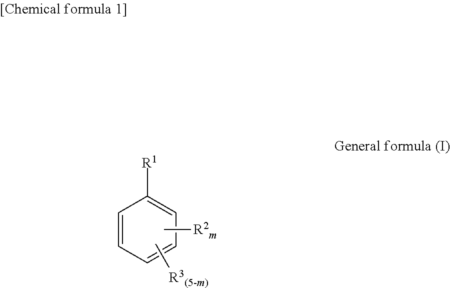

(In formula (I), m is an integer of 1 to 5; R¹ is a carboxyl group; R² is an aldehyde group, a carboxyl group, an amino group, a hydroxyl group, or a sulfonic acid group; R³ is hydrogen or an arbitrary substituent, when m is 2 or more, multiple R²'s may be the same or different from each other, and when m is 3 or less, multiple R³'s may be the same or different from each other, and R¹ and R² may each independently be bonded to a benzene ring via a divalent group constituted by at least one selected from the group consisting of —O— and —CH₂—).

[14] The composite material manufacturing method according to any one of to [13], wherein the metal sulfide constituting the metal sulfide particles is at least one selected from the group consisting of molybdenum sulfide, tungsten sulfide, and tin sulfide.

[15] The composite material manufacturing method according to any one of to [14], wherein the metal sulfide particles have a volume-based cumulative 50% particle size (D50) of 0.5 to 15 μm as measured by a laser diffraction/scattering particle size distribution analyzer.

[16] The composite material manufacturing method according to any one of to [15], wherein the metal sulfide constituting the metal sulfide particles is at least one selected from the group consisting of MoS₂ and WS₂.

[17] A terminal in which the composite material according to any one of [1] to is used as a constituent material thereof.

[18] A terminal manufacturing method, including: processing the composite material according to any one of [1] to into a shape of a terminal.

### Advantage of the Invention

According to the present invention, there are provided a composite material having sufficient wear resistance for practical use, with suppressed silver shedding from a composite coating during bending, and a manufacturing method for the composite material, and related techniques.

### BRIEF DESCRIPTION OF THE DRAWINGS

FIG. 1 is a schematic cross-sectional view explaining a test for evaluating silver shedding during bending, according to an example.

### DETAILED DESCRIPTION OF THE INVENTION

Hereinafter, an embodiment of the present invention will be described.

### [Composite Material Manufacturing Method]

The composite material manufacturing method according to one embodiment of the present invention is a method for manufacturing a composite material, including: performing electroplating in a silver plating solution containing metal sulfide particles, thereby forming a composite coating on a base material, the composite coating containing the metal sulfide particles in a silver layer. Each configuration of the composite material manufacturing method will be described below.

### <<Base Material>>

As the base material with the composite coating formed thereon, materials that can be plated with silver and has electrical conductivity required for sliding contact parts such as switches and connectors are preferably used, and further, from the viewpoint of a cost, Cu (copper) and a Cu alloy are preferable as the constituent materials. As the Cu alloy, from the viewpoint of achieving both electrical conductivity and wear resistance, an alloy composed of Cu, and at least one selected from the group consisting of Si (silicon), Fe (iron), Mg (magnesium), P (phosphorus), Ni (nickel), Sn (tin), Co (cobalt), Zn (zinc), Be (beryllium), Pb (lead), Te (tellurium), Ag (silver), Zr (zirconium), Cr (chromium), Al (aluminum), Ti (titanium), B (boron), Li (lithium) and Bi (bismuth), and inevitable impurities, is preferable. An amount of Cu in the Cu alloy is preferably 85 mass % or more, and more preferably 92 mass % or more (the amount of Cu is preferably 99.95 mass % or less).

As described below, the base material is preferably used for a terminal application (as a composite material with a composite coating formed thereon), in which the base material itself may have a shape for such an application, or the base material may be flat (such as a flat plate) and then formed into the shape for the application after it has been processed into a composite material. From the viewpoint of exhibiting the effect of the present invention, it is preferable that the base material has a flat shape such as a flat plate shape.

### <<Formation of an Underlayer>>

In the composite material manufacturing method of the present invention, an underlayer may be formed on the base material, and the underlayer may be subjected to electroplating described below. The underlayer is formed for the purpose of preventing the copper of the base material from diffusing through to a plating surface and oxidizing, resulting in deteriorating the electrical conductivity of the composite material, and for the purpose of improving the adhesion of the composite coating.

The constituent metal of the underlayer is at least one metal selected from the group consisting of Cu, Ni, Sn, and Ag, or an alloy of them. The underlayer may be a single layer of Cu, Ni, Sn, Ag or an alloy thereof, or a combination of these (a layered structure). The underlayer may be formed on an entire surface layer of the base material or only on a part of the surface layer, depending on the application of the composite material to be manufactured.

There is no particular limit in the method for forming the underlayer, and the underlayer can be formed by electroplating using a plating solution containing ions of the above-described constituent metals by a known method, or by sequentially laminating layers composed of metals that constitute a target alloy layer and then applying reflowing (heat treatment) to the laminated layers.

### <<Ag Strike Plating>>

Before forming the composite coating on the base material, it is preferable to form a very thin intermediate layer by Ag strike plating to improve adhesion between the base material and the composite coating. When forming the underlayer on the base material, Ag strike plating is performed onto the underlayer. As a method for performing Ag strike plating, any conventionally known method can be used without particular limit as long as it does not impair the effect of the present invention.

### <<Electroplating>>

In the composite material manufacturing method of the present invention, the above-described base material is electroplated in a specific silver plating solution to thereby form a composite coating on the base material, the composite coating containing metal sulfide particles in a silver layer.

### <Silver Plating Solution>

The silver plating solution contains silver ions and metal sulfide particles, and preferably contains a specific compound A.

### (Silver Ions)

The silver plating solution contains silver ions. From the viewpoints of a composite coating formation rate and suppressing unevenness in the appearance of the composite coating, the silver concentration in the silver plating solution is preferably to 150 g/L, more preferably 10 to 120 g/L, and most preferably 20 to 100 g/L.

### (Metal Sulfide Particles)

Next, the silver plating solution contains metal sulfide particles. When the silver plating solution contains metal sulfide particles, the particles are entrapped in the silver matrix when the composite coating (silver plating film) is formed on the base material by electroplating. These metal sulfide particles are a substance that undergoes layer-by-layer exfoliation (delamination), and when the composite coating contains the metal sulfide particles, the wear resistance of the composite material is increased. An amount of the metal sulfides that delaminate is so small that they do not cause contamination.

Further, when silver plating is performed using a specific plating solution employing carbon particles as described in Patent document 5, the above-described nodular electrodeposition structure is generated. However, when silver plating is performed using metal sulfide particles as described in the present invention, probably, some change occurs in the formation of the silver matrix during plating. This suppresses the generation of the nodular electrodeposition structures, resulting in formation of the composite coating with a small arithmetic mean roughness Ra and a small value X obtained by dividing the arithmetic mean roughness Ra by the thickness of the composite coating. This composite coating is extremely resistant to silver shedding during bending. The mechanism of generating the nodular electrodeposition structure is considered to be that when electricity is passed through some of the carbon particles, silver is deposited on the particles, and this silver grows to generate the nodules. It is considered that metal sulfide particles have a higher electrical resistance than carbon particles, and therefore it is difficult for electricity to pass through the metal sulfide particles, and as a result, the nodular electrodeposition structure is unlikely to be generated.

From the viewpoint of wear resistance, the metal sulfide constituting the metal sulfide particles is preferably at least one selected from the group consisting of molybdenum sulfide, tungsten sulfide, and tin sulfide. The metal sulfide particles are particularly preferably at least one selected from the group consisting of MoS₂ and WS₂ taking into consideration that they are easily entrapped in the silver matrix by electroplating.

From the viewpoints of ease of entrap in the silver plating film and wear resistance of the silver plating film, the metal sulfide particles preferably have a volume-based cumulative 50% particle size (D50) of 0.5 to 15 μm, more preferably 1 to 10 μm, and particularly preferably 3.5 to 10 μm from the viewpoint of wear resistance, as measured by a laser diffraction/scattering particle size distribution analyzer. Further, the shape of the metal sulfide particles is not particularly limited and may be approximately spherical, flaky, or amorphous. However, flaky shape is preferable because it can increase the wear resistance of the composite material by smoothing the surface of the composite coating.

The metal sulfide particles may be subjected to an oxidation treatment or a basification treatment to remove lipophilic organic substances adsorbed on the surfaces of the particles. Such lipophilic organic substances include aliphatic hydrocarbons such as alkanes and alkenes, and aromatic hydrocarbons such as alkylbenzenes. By subjecting the metal sulfide particles to an oxidation treatment or a basification treatment, lipophilic organic substances such as aliphatic and aromatic hydrocarbons can be removed from the surfaces of the particles. This allows the particles to be dispersed more uniformly in the silver plating solution used in the present invention, and also increases the amount of metal sulfide particles entrapped in the silver plating solution. It is also considered that compound A in the silver plating solution described below functions favorably. As a result, the composite coating having high hardness and a low coefficient of friction can be formed. Further, when molybdenum sulfide particles having D50 of 3.5 to 10 μm are subjected to the oxidation treatment or the basification treatment, particularly preferably the basification treatment, followed by silver plating, a composite coating having particularly high wear resistance can be formed.

As a technique of the oxidation treatment, for example, there is a wet oxidation treatment. As a method for the wet oxidation treatment, there is a method in which metal sulfide particles are suspended in water and then an appropriate amount of an oxidizing agent is added thereto. Examples of the oxidizing agent that can be used include nitric acid, hydrogen peroxide, potassium permanganate, potassium persulfate, sodium perchlorate, etc.

As a technique of the basification treatment, for example, there is a wet basification treatment. As a method for the wet basification method, for example there is a method in which metal sulfide particles are brought into contact with an alkaline aqueous solution, and as a specific method, there is a method in which metal sulfide particles are suspended in water and then an appropriate amount of an alkaline substance is added thereto. Examples of the alkaline substances include potassium hydroxide, sodium hydroxide, calcium hydroxide, and lithium hydroxide, etc. From the viewpoint of forming the composite coating having high wear resistance, the basification treatment is preferably performed by adding an alkaline substance so that pH of the water in which the metal sulfide particles are suspended becomes 12 or more. The introduction of a hydrophilic group (e.g., hydroxyl group) onto the surfaces of the metal sulfide particles by the basification treatment is also considered to contribute to the dispersibility of the particles in the silver plating solution.

The amount of metal sulfide particles in the silver plating solution is preferably to 200 g/L, more preferably 25 to 150 g/L, and most preferably 50 to 120 g/L, from the viewpoint of the wear resistance of the composite material obtained by forming a composite coating on a base material using a silver plating solution, and of the limit in the amount of particles that can be introduced into the composite coating.

### (Compound A)

Next, the silver plating solution used in the composite material manufacturing method of the present invention preferably contains compound A represented by the following general formula (I).

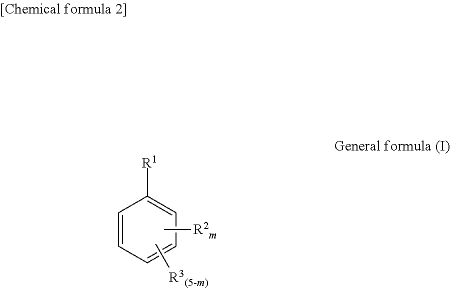

In formula (I), m is an integer of 1 to 5, R¹ is a carboxyl group, R² is an aldehyde group, a carboxyl group, an amino group, a hydroxyl group or a sulfonic acid group, R³ is hydrogen or an arbitrary substituent, and R¹ and R² may each independently be bonded to a benzene ring via a divalent group constituted by at least one selected from the group consisting of —O— and —CH₂—. Examples of the divalent group include —CH₂—CH₂—O—, —CH₂—CH₂—CH₂—O—, and (—CH₂—CH₂—O—) n (n is an integer of 2 or more).

It is considered that compound A is adsorbed onto the surface of deposited silver and inhibits the growth of silver crystals, thereby decreasing the crystallite size of silver in the composite coating to be formed by electroplating. This results in the composite coating with high hardness and therefore high wear resistance.

In the above general formula (I), when m is 2 or more, multiple R²s may be the same or different, and when m is 3 or less, multiple R³s may be the same or different. For R³, examples of the “arbitrary substituent” include an alkyl group having 1 to 10 carbon atoms, an alkylaryl group, an acetyl group, a nitro group, a halogen group, and an alkoxyl group having 1 to 10 carbon atoms.

The concentration of compound A in the silver plating solution is preferably 2 to 250 g/L, and more preferably 3 to 200 g/L, from the viewpoints of suppressing unevenness in the appearance of the composite coating and appropriately controlling the crystallite size of silver in the composite coating to be formed.

### (Complexing Agent)

The silver plating solution used in the present invention preferably contains a complexing agent. The complexing agent complexes the silver ions in the silver plating solution, thereby increasing the stability of the ions. This action increases the solubility of silver in the solvent that constitutes the plating solution.

Any conventionally known complexing agent can be used without any particular limit, but from the viewpoint of the stability of the formed complex, a compound having a sulfonic acid group is preferable. Examples of the compound having the sulfonic acid group include alkylsulfonic acid having 1 to 12 carbon atoms, alkanolsulfonic acid having 1 to 12 carbon atoms and hydroxyarylsulfonic acid. Specific examples of these compounds include methanesulfonic acid, 2-propanolsulfonic acid, and phenolsulfonic acid.

The amount of the complexing agent in the silver plating solution is preferably to 200 g/L, and more preferably 50 to 120 g/L, from the viewpoint of stabilizing the silver ions.

### (Other Additive)

As other additive, for example, the silver plating solution used in the present invention may contain a brightener, hardener, and conductive salt.

### (Solvent)

The solvent constituting the silver plating solution is mainly water. Water is preferable because of its ability to dissolve (complexed) silver ions and other components contained in the plating solution, and because water poses little environmental burden. Further, a mixed solvent of water and alcohol may be used as the solvent.

### <Electroplating Conditions>

Next, various conditions for electroplating using the above-described silver plating solution will be described. For example, by performing electroplating as described below, metal silver is deposited on the base material, and at the same time, the above-described metal sulfide particles are entrapped in the silver matrix, resulting in the formation of the composite coating. When the underlayer is formed on the base material, the composite coating is formed on the underlayer, and when silver strike plating is performed, the composite coating is formed on the strike plating layer.

### (Cathode and Anode)

The base material to be electroplated is a cathode. What dissolves to provide silver ions, e.g. a silver electrode plate is an anode.

### (Current Density)

The cathode and the anode are immersed in a silver plating solution (plating bath), and a current is applied to perform silver plating. The current density here is preferably 0.3 to 10 A/dm², more preferably 0.5 to 8 A/dm², and even more preferably 0.8 to 6 A/dm², from the viewpoints of the formation rate of the composite coating and suppressing the unevenness in the appearance of the composite coating.

### (Temperature, Stirring, Plating Time, Area to be Plated)

The temperature (plating temperature) of the plating bath (silver plating solution) during electroplating is preferably 15 to 50° C., more preferably 20 to 45° C., from the viewpoints of plating production efficiency and preventing excessive evaporation of the solution. In this case, the plating bath is preferably stirred at 200 to 550 rpm, and more preferably at 350 to 500 rpm, from the viewpoint of performing uniform plating. The silver plating time (time for applying electric current) can be appropriately adjusted depending on a desired thickness of the composite coating, but is typically in a range of 25 to 4500 seconds. The area to be plated may be an entire surface layer of the base material or a part of the surface layer of the base material, depending on the application of the composite material to be manufactured.

In order to form a high wear resistant composite coating in terms of suppressing silver shedding from the composite coating during bending, it is preferable to set the silver plating time to 2000 seconds or less.

<<Partial Removal Treatment of the Metal Sulfide Particles from the Surface of the Composite Coating>>

By the electroplating described above, the composite coating is formed on the base material. On the surface of the coating, there are metal sulfide particles that are entrapped (embedded) in the silver matrix and are therefore difficult to fall off, and there are metal sulfide particles that are attached to the surface rather than being entrapped and are therefore more likely to fall off. The latter possibly contaminates equipment, for example during bending of the composite material. Therefore, it is preferable to remove such metal sulfide particles by cleaning. One cleaning method is to subject the surface of the composite coating to ultrasonic cleaning. The ultrasonic cleaning is preferably performed at 20 to 100 kHz for 1 to 300 seconds. Another cleaning method is electrolytic cleaning, which is preferably performed at 1 to 30 A/dm² for 10 to 300 seconds.

### [Composite Material]

Hereinafter, the composite material according to one embodiment of the present invention will be described. The composite material is a composite material in which the composite coating containing metal sulfide particles in a silver layer, is formed on the base material. This composite material can be manufactured, for example, by the composite material manufacturing method of the present invention. Each configuration of this composite material will be described below.

### <<Base Material>>

The base material is the same as that described above in the composite material manufacturing method of the present invention. That is, Cu (copper) and a Cu alloy are suitable as constituent materials of the base material, and as the Cu alloy, from the viewpoint of achieving both electrical conductivity and wear resistance, an alloy composed of Cu, and at least one selected from the group consisting of Si (silicon), Fe (iron), Mg (magnesium), P (phosphorus), Ni (nickel), Sn (tin), Co (cobalt), Zn (zinc), Be (beryllium), Pb (lead), Te (tellurium), Ag (silver), Zr (zirconium), Cr (chromium), Al (aluminum), Ti (titanium), B (boron), Li (lithium) and Bi (bismuth), and inevitable impurities, is preferable.

### <<Composite Coating>>

The composite coating formed on the base material is composed of a silver layer containing metal sulfide particles. In this silver layer, the metal sulfide particles are dispersed (preferably substantially uniformly) in the matrix composed of silver. When Ag strike plating is performed before forming the composite coating, an intermediate layer of this strike plating exists between the base material (or the underlayer described below) and the composite coating, but in many cases, the intermediate layer is so thin that it cannot be distinguished from the composite coating. The composite coating may be formed on an entire surface layer of the base material, or on only a part of the surface layer.

### <Metal Sulfide Particles>

The metal sulfide particles are the same as the metal sulfide particles described above in relation to the composite material manufacturing method of the present invention. That is, the metal sulfide constituting the particles is preferably at least one selected from the group consisting of molybdenum sulfide, tungsten sulfide, and tin sulfide, and particularly preferably MoS₂ and WS₂, and there is no particular limit in the shape of the metal sulfide particles and the shape may be substantially spherical, flaky, or amorphous. However, a flaky shape is preferable because it increases the wear resistance of the composite material by smoothing the surface of the composite coating.

An average primary particle size of the metal sulfide particles is preferably 0.5 to 15 μm, and more preferably 3 to 10 μm, from the viewpoint of the wear resistance of the composite material. The average primary particle size is the average value of the long diameters of the particles, and the long diameter is defined as a length of a longest line that can be drawn within a particle in an image (plane) of the metal sulfide particle in the composite coating of the composite material observed at an appropriate observation magnification. The long diameter is determined for 50 or more particles.

The presence of the metal sulfide particles in the composite coating is distinguishable by X-ray diffraction (XRD) analysis. More specifically, for the surface of the composite coating, X-ray diffraction measurement is performed in accordance with JIS H7805: 2005, using an X-ray diffractometer. Peaks are measured using X-ray analysis software (e.g., PDXL manufactured by Rigaku Co., Ltd.), and the measured peaks are compared with X-ray diffraction patterns recorded on the JCPDS card of metal sulfides such as MoS₂ (which contains information such as diffraction peaks, lattice spacing, and lattice number of each crystal), and peaks identified as metal sulfides such as MoS₂ are confirmed in addition to Ag peaks. This enables to check the presence of the metal sulfide particles in the composite coating.

### <Arithmetic Mean Roughness Ra of the Composite Coating and the Thickness of the Composite Coating>

The composite coating of the present invention has a surface morphology with few nodules, and the value X obtained by dividing the arithmetic mean roughness Ra (μm) by the thickness (μm) of the composite coating is 0.14 or less. The present inventors' investigation has revealed that the thicker the composite coating, the more likely the nodules are to be formed and the larger they become, and for the ease of the silver shedding from the composite coating during bending, it is also revealed that the value X is a more effective indicator than Ra itself that represents the surface morphology. From the viewpoint of suppressing the silver shedding from the composite coating during bending, and because it is difficult to manufacture a composite material having a composite coating with a very small value of X, the value X is preferably 0.01 to 0.12, and more preferably 0.02 to 0.11.

The arithmetic mean roughness Ra of the composite coating of the composite material of the present invention is preferably 0.1 to 3.0 μm, more preferably 0.1 to 2.1 μm, from the viewpoint of wear resistance. Details of the method for measuring Ra will be described in the Examples.

There is no particular limit in the thickness of the composite coating of the composite material of the present invention, but it is preferable that the thickness be at least a minimum in terms of wear resistance and electrical conductivity. If the thickness is too large, the effect of the composite coating becomes saturated and a raw material cost increases. From the above viewpoints, the thickness of the composite coating is preferably 0.5 to 45 μm, more preferably 0.5 to 35 μm, and even more preferably 1 to 25 μm. When taking into consideration the need to suppress silver shedding during bending, the thickness of the composite coating is most preferably 1 to 10 μm. Details of the method for measuring the thickness of the composite coating will be described in the Examples. As described above, when Ag strike plating is performed, an intermediate layer by this strike plating exists between the base material (or the underlayer described below) and the composite coating, but when it is not possible to distinguish the intermediate layer from the composite coating, the thickness of the intermediate layer is included in the thickness of the composite coating.

### <Crystallite Size and Vickers Hardness>

The crystallite size of silver in the composite coating of the composite material according to one embodiment of the present invention is preferably 62 nm or less. Such a small crystallite size leads to a high hardness of the composite coating due to the Hall-Petch relationship (generally, the smaller the crystal grains of a metal material, the stronger it is). High hardness makes the composite coating less susceptible to wear, tending to increase the wear resistance of the composite material. Further, there is a limit in how small the crystallite size can be made. From these points of view, the crystallite size is more preferably 6 to 60 nm, and particularly preferably 10 to 60 nm. The crystallite size may be controlled to be 35 to 58 nm. From the viewpoint of achieving both wear resistance and suppressing silver shedding during bending, the crystallite size of silver is particularly preferably 62 nm or less and the value X is 0.088 or less.

In the present invention, the crystallite size of a crystal plane having maximum intensity in XRD analysis, is adopted as a crystallite size of silver. A more detailed method for measuring the crystallite size will be described in the Examples.

As described above, the composite coating preferably has a small crystallite size and therefore a high hardness. Specifically, the Vickers hardness Hv is preferably 100 or more, and more preferably 110 to 230. Details of the method for measuring the Vickers hardness Hv will be described in the Examples.

### <Mass Ratio of the Metal Sulfide Particles on the Surface of the Composite Coating and Content of the Metal Sulfide Particles in the Composite Coating>

As described above, the composite coating of the composite material according to one embodiment of the present invention contains the metal sulfide particles, and the mass ratio of the particles on the surface of the composite coating is preferably 1 to 50 mass %, more preferably 2 to 35 mass %, and even more preferably 3 to 25 mass %, from the viewpoints of the wear resistance and electrical conductivity of the composite material. As described in the description of the composite material manufacturing method of the present invention, the metal sulfide particles that are merely attached and therefore are likely to fall off may be present on the surface of the composite coating in some cases. In this case, the mass proportion of the metal sulfide particles on the surface of the composite coating is obtained after performing ultrasonic cleaning treatment similar to that explained in the section <<Partial removal treatment of the metal sulfide particles from the surface of the composite coating>>. The mass proportion of the metal sulfide particles on the surface of the composite coating can be obtained by energy dispersive X-ray analysis, and the details of this measurement method will be described in the Examples.

Further, the content of the metal sulfide particles in the composite coating containing the metal sulfide particles is preferably 0.5 to 30 mass %, more preferably 0.8 to 30 mass %, even more preferably 1 to 20 mass %, and particularly preferably 1.5 to 10 mass %, from the viewpoint of a balance between the wear resistance and electrical conductivity. From the viewpoint of the wear resistance, it is particularly preferable that the metal sulfide is molybdenum sulfide and that the content thereof in the composite coating is 2.5 to 10 mass %. Details of the measurement method for the content will be described in the Examples.

### <Total Content of the Silver and Metal Sulfide>

Regarding elemental composition, the composite coating of the composite material according to one embodiment of the present invention typically consists essentially of silver and metal sulfide (metal and sulfur). Specifically, the total content of these elements in the composite coating is 99 mass % or more, and more preferably 99.5 mass % or more.

### <<Underlayer>>

An underlayer may be formed between the base material and the composite coating for various purposes. The constituent metal of the underlayer is at least one metal selected from the group consisting of Cu, Ni, Sn, and Ag, or an alloy of them. For example, in order to prevent copper in the base material from diffusing through to the surface of the composite coating and prevent deteriorating the electrical conductivity, it is preferable to form an underlayer composed of Ni. When the base material is a copper alloy containing zinc, such as brass, in order to prevent the zinc in the base material from diffusing through to the surface of the composite coating, it is preferable to form an underlayer composed of Cu. For the purpose of improving the adhesion of the composite coating to the base material, it is preferable to form an underlayer composed of Ag. There is no particular limit in the thickness of the underlayer, but from the viewpoints of a function and cost, it is preferable to set the thickness to 0.1 to 2 μm, and more preferably 0.2 to 1.5 μm. Further, a material that has undergone Sn plating or reflow Sn plating including Cu undercoat or Ni undercoat (layered structure of Cu, Ni, and Sn from the base material side), is often used for terminals of electrical and electronic components, and in the present invention as well, an underlayer having such a layered structure may be formed. Accordingly, in the present invention, the undercoat of the composite coating may be a single layer of Cu, Ni, Sn, Ag or an alloy thereof, or a layer of a combination of these (a layered structure). Also, different layers may be formed depending on a location, for example by forming the composite coating as defined in the present invention on the electrical contact parts of the base material (with or without forming the underlayer) and forming a reflow Sn-plated underlayer on a wire crimping portion (without forming the composite coating).

### <<Wear Resistance>>

The composite material according to one embodiment of the present invention have high wear resistance. Specifically, when the wear resistance is evaluated by the method using a flat test piece and an indented test piece in the Examples described below, no exposure of the base material is observed in the flat test piece after 1000 reciprocal sliding operations, preferably after 2,500 reciprocal sliding operations, and particularly preferably after 10,000 reciprocal sliding operations. Further, the number of reciprocal cycles required for decreasing the thickness of the composite coating by 1 μm, as obtained by the above test, is preferably 300 or more, more preferably 600 or more, and particularly preferably 900 or more (usually 3000 or less).

<<Silver Shedding from the Composite Coating During Bending>>

As described above, in the composite material according to one embodiment of the present invention, the value X (Ra/thickness of the composite coating) is as small as 0.14 or less, and silver shedding from the composite coating during bending is suppressed. Specifically, in a test for evaluating silver shedding due to bending in the Examples described below, the peeled carbon tape is subjected to EDS analysis using an energy dispersive X-ray analyzer, which reveals that the proportion of Ag is preferably 15 mass % or less, more preferably 10% by mass or less, further preferably 5% by mass or less, particularly preferably 3% by mass or less, and most preferably 1.2% by mass or less, when the total of the detected elements (Ag, elements constituting metal sulfides (Mo, S, etc.), and C, etc.) is taken as 100 mass %. It is difficult to reduce the proportion of Ag to 0, and it is usually 0.1 mass % or more.

### [Terminal]

The composite material according to one embodiment of the present invention has sufficient wear resistance for practical use and is suppressed from silver shedding from the composite coating during bending, thus making it suitable as a constituent material for terminals, particularly terminals in electrical contact parts such as switches and connectors that undergo sliding during use.

The terminal can be manufactured by processing the composite material of the present invention, which is not yet in the shape of a terminal, such as a flat plate, into the shape of a terminal through a shearing processing such as punching or a bending processing.

### EXAMPLES

Hereinafter, examples of the composite material and the composite material manufacturing method according to the present invention will be described in detail.

### <Preparation of the Metal Sulfide Particles>

Flaky MoS₂ particles (Moly Powder PA, manufactured by Sumitomo Lubricants Co., Ltd.) having a volume-based cumulative 50% particle size (D50) of 5 μm as measured by a laser diffraction/scattering particle size distribution analyzer, were prepared. The D50 is the nominal value of the MoS₂ particles provided by the manufacturer.

### [Example 1] <Ag Strike Plating>

A test piece measuring 1.0 cm in width×4.0 cm in length was cut out from a 0.2 mm thick Cu—Ni—Sn—P alloy plate (a copper alloy plate containing 1.0 mass % of Ni, 0.9 mass % of Sn, 0.05 mass % of P, with the balance being Cu and unavoidable impurities) (NB109EH manufactured by Dowa Metaltech Co., Ltd.). Using this test piece as the base material, and with this base material used as a cathode and a titanium mesh electrode plate (a titanium mesh material coated with iridium oxide) used as an anode, electroplating (Ag strike plating) was performed for 90 seconds at a current density of 5 A/dm² in a sulfonic acid-based Ag strike plating solution containing methanesulfonic acid as a complexing agent (Dain Silver GPE-ST manufactured by Daiwa Kasei Co., Ltd., silver concentration: 3 g/L, methanesulfonic acid concentration: 42 g/L, temperature: 25° C.). The Ag strike plating was performed to an entire surface of the base material.

### <Ag-MoS₂ Plating>

The above-described MoS₂ particles were added as metal sulfide particles to a sulfonic acid-based silver plating solution containing methanesulfonic acid as a complexing agent (Dain Silver GPE-HB (containing compound A corresponding to general formula (I) and mainly water as a solvent) manufactured by Daiwa Kasei Co., Ltd.), having a silver concentration of 30 g/L and a methanesulfonic acid concentration of 60 g/L, to prepare a metal sulfide particle-containing sulfonic acid-based silver plating solution containing metal sulfide particles at a concentration of 100 g/L, silver at a concentration of 30 g/L, methanesulfonic acid at a concentration of 60 g/L, and compound A at a concentration of 4.2 g/L.

Next, with the above Ag strike plated base material used as a cathode and the silver electrode plate used as an anode, electroplating was performed in the above sulfonic acid-based silver plating solution containing metal sulfide particles for 855 seconds at a temperature of 25° C. and a current density of 1 A/dm² while stirring with a stirrer at 400 rpm, to obtain a composite material in which a composite coating (Ag—MoS₂ plating coating) containing metal sulfide particles in a silver layer was formed on the base material. The composite coating that consists essentially of silver and metal sulfide particles, was formed over an entire surface of the base material.

### <Ultrasonic Cleaning Treatment>

The surface of the composite coating of the obtained composite material was subjected to ultrasonic cleaning treatment at 28 kHz for 4 minutes using an ultrasonic cleaner (VS-100III manufactured by AS ONE, output: 100 W, tank dimensions: 140 mm in length×240 mm in width×100 mm in depth, used liquid: pure water, water temperature: 20° C.).

The manufacturing conditions for the above composite material are summarized in Table 1 below, together with the manufacturing conditions in Examples 2 to 7 and Comparative Examples 1 and 2 described below.

The obtained composite material (which had been subjected to ultrasonic cleaning treatment) was evaluated as follows.

### <Thickness of the Composite Coating>

The thickness of the composite coating of the composite material (a circular range with a diameter of 0.2 mm at the center of a 1 cm×4 cm surface) was measured using a fluorescent X-ray thickness meter (FT110A manufactured by Hitachi High-Tech Science Co., Ltd), which revealed that the thickness was 5.1 μm. The thickness of the composite coating was obtained from the fluorescent X-ray intensity of Ag, regarding the composite coating as an Ag film.

### <Arithmetic Mean Roughness Ra of the Composite Coating>

Regarding an image obtained by photographing the surface of the above composite coating at a magnification of 1000 times using a laser microscope (VKX-110 manufactured by Keyence Co., Ltd.), the arithmetic mean roughness Ra that is a parameter that represents a surface roughness (over an entire observation surface of the composite coating), was calculated based on JIS B0601 (2001) using an analysis application (VK-HIXA version 3.8.0.0 manufactured by Keyence Co., Ltd.), which revealed that the arithmetic mean roughness Ra was 0.3 μm. Therefore, the value X obtained by dividing the arithmetic mean roughness Ra of the composite coating by the thickness (μm) of the composite coating was 0.059.

### <Content of the Metal Sulfide Particles or Carbon Particles in the Composite Coating>

For the surface of the composite coating, X-ray diffraction measurement was performed in accordance with JIS H7805:2005, using an X-ray diffraction device (D2Phaser 2nd Generation manufactured by Bruker Japan Co., Ltd.) (Cu Kα tube, tube voltage: 30 kV, tube current: 10 mA, step width: 0.02°, scanning range: 20=10° to 155°, scan speed: 5°/min, measurement time: approximately 30 minutes). Peaks were measured using X-ray analysis software (PDXL manufactured by Rigaku Co., Ltd.), and the measured peaks were compared with the X-ray diffraction pattern recorded on the JCPDS card of MoS₂ (which records information such as diffraction peaks, lattice spacing, and lattice number of each crystal), which revealed that a peak identified as MoS₂ was confirmed in addition to the Ag peak. In Example 5 described below, the measured peaks were compared with the X-ray diffraction pattern of the JCPDS card of WS₂ instead of MoS₂, which revealed that a peak identified as WS₂ was confirmed in addition to the Ag peak.

The contents (mass %) of Ag and Mo (W in Example 5) in the composite coating were obtained by ICP-OES (Agilent 5800 ICP-OES spectrometer manufactured by Agilent Technologies Co., Ltd.) (plasma spectroscopic analysis), specifically, as follows.

0.5 g of the composite material (the constituent elements of the base material and the plating film are different) was weighed, 5 mL of nitric acid was added thereto, and the mixture was heated and dissolved at 150 to 200° C. for 10 to 20 minutes. The solution was allowed to cool to room temperature and filtered through an MCE membrane filter (0.45 μm mesh, filter diameter: 47 mm), and a filtrate was adjusted to a constant volume of 100 mL with pure water (test solution A). For a filtration residue, 5 mL of nitric acid and 4 mL of a mixture of sulfuric acid and water (volume ratio 1:1) were added, and the mixture was heated at 200 to 250° C. to dissolve the residue. The solution was allowed to cool to room temperature and the volume was adjusted to 100 mL with pure water (test solution B).

The test solutions A and B obtained above were subjected to ICP-OES to obtain the amount of each element contained in the sample of the composite material. Among the detected elements, attention was focused on Ag and Mo, and the MoS₂ content was calculated based on the total amount of Mo (in the case of Example 5, the WS₂ content was obtained). Specifically, when the Ag content in the composite coating was expressed as X (mass %) and the MoS₂ content was expressed as Y (mass %), the MoS₂ content in the composite coating was calculated using formula Y/(X+Y) (mass %).

In Comparative Examples 1 and 2 described below, C content (Z mass %) constituting the carbon particles is obtained using a trace carbon/sulfur analyzer (EMIA-810W manufactured by Horiba, Co., Ltd.) (by an infrared absorption method). Then, the carbon particle content in the composite coating was obtained using Z/(X+Z) (mass %) using (Ag content (X mass %)).

### <An Amount of the Metal Sulfide Particles or Carbon Particles on the Surface of the Composite Coating>

The surface of the composite coating was observed using a tabletop electron microscope (TM4000 Plus manufactured by Hitachi High-Technologies Co., Ltd.) at an accelerating voltage of 15 kV and a magnification of 1000 times, and this observation area (one visual field) was subjected to EDS analysis using an energy dispersive X-ray analyzer (AztecOne manufactured by Oxford Instruments Co., Ltd.) attached to the above tabletop electron microscope. Thus, the Ag content and Mo content in the composite coating were obtained (W content was obtained in Example 5 described below, and C content was obtained in Comparative Examples 1 and 2).

Thereafter, the amount of MoS₂ was calculated based on the amount of Mo (in the case of Example 5, the amount of WS₂ was calculated). Then, when the amount of Ag on the surface of the composite coating is expressed as S (mass %) and the amount of MoS₂ is expressed as T (mass %), the amount of MoS₂ on the surface of the composite coating was obtained using formula T/(S+T) (mass %).

### <Crystallite Size of Silver in the Composite Coating>

For the surface of the composite coating, X-ray diffraction measurement was performed in accordance with JIS H7805:2005, using an X-ray diffraction device (D2 Phaser 2nd Generation manufactured by Bruker Japan Co., Ltd.) (Cu Kα tube, tube voltage: 30 kV, tube current: 10 mA, step width: 0.02°, scanning range: 20=10° to 155°, scanning speed: 5°/min, measurement time: approximately 30 minutes, 111 plane peak: 20=37.9 to 38.7°, 220 plane peak: 20=64.5 to) 65.8°. From a strongest line peak, which has the highest peak intensity among the detected silver peaks, a full width at half maximum (FWHM) was calculated using X-ray analysis software (PDXL manufactured by Rigaku Co., Ltd.), and the crystallite size of a plane that is a strongest line of silver was calculated using Scherrer's formula. In Example 1, the strongest line peak was a 220 plane peak, and the crystallite size was 51.6 nm.

The Scherrer formula is as follows:

$$\begin{matrix}D = K λ / ( β cos θ ) \\ D : crystallite size \\ K : Scherrer constant , set to 0.9 \\ λ : X - ray wavelength , 1.54 Å for CuK α radiation \\ β : full width at half maximum ( FWHM ) ( rad ) \\ θ : measurement angle ( deg )\end{matrix}$$

### <Vickers Hardness Hv of the Surface of the Composite Coating>

For the Vickers hardness Hv of the surface of the composite coating, a load of 0.01 N was applied to a flat part of the composite material for 10 seconds using a microhardness tester (HM221 manufactured by Mitutoyo Co., Ltd.), and the Vickers hardness Hv of the surface of the composite coating was measured in accordance with JIS Z2244, and an average value of three measurements was adopted. As a result, the Vickers hardness was 146 Hv.

### <Evaluation of the Wear Resistance and Coefficient of Friction>

The Cu—Ni—Sn—P alloy plate material that is the same as used in Example 1 was plated with AgSb in the same manner as in Comparative Example 1 described below, and a test piece measuring 1.0 cm in width×4.0 cm in length was cut out from the plated material, and this was subjected to indentation (extrusion into a hemispherical shape) having an inner diameter of 1.0 mm. The thickness of the composite coating (AgSb plating film) in the indented test piece was 40 to 60 μm.

A reciprocating sliding motion (sliding distance: 10 mm (i.e., 20 mm per reciprocation), sliding speed: 10 mm/s) was continuously performed to the composite material (flat test piece) obtained in the above Example 1, using a sliding wear tester (CRS-G2050-DWA manufactured by Yamazaki Seiki Research Co., Ltd.), while pressing an indented test piece (indenter) against the test piece with a constant load (5N) in such a manner that a convex portion of the indenter was brought into contact with the flat test piece.

For the coefficient of friction, the coefficient of friction was measured by measuring the sliding load from start of sliding to a sliding distance of 5 mm. Then, sliding load data from a sliding distance of 2 mm to 3 mm was averaged to obtain the coefficient of friction (average sliding load: F/5N). As a result, the coefficient of friction was 0.21.

For the wear resistance, the above reciprocal sliding operation was continued, and a wear state of the flat test piece was checked at the time points when the reciprocal sliding operation had been performed 1000 times and 2500 times. Specifically, the center of a sliding mark of the flat test piece was observed using a microscope (VHX-1000 manufactured by Keyence Co., Ltd.) at a magnification of 200 times to check from the sliding mark whether the base material (a brown alloy plate material) was exposed.

Further, the amount of decrease in the thickness of the composite coating after 1000 reciprocal sliding operations was obtained, and from this, the number of cycles was obtained, required for decreasing the thickness of the composite coating by 1 μm by the reciprocal sliding operation. In Comparative Example 2 described below, the base material was exposed before 1000 reciprocal sliding operations, and the number of cycles required for decreasing the thickness by 1 μm was calculated from the number of cycles at that point (550 cycles).

### <Silver Shedding Due to Bending>

A bending test piece having 10 mm in width and 30 mm in length was cut out from the obtained composite material so that a longitudinal direction was TD (direction perpendicular to a rolling direction) and a width direction was LD (rolling direction), and for this bending test piece, 90° W bending test was performed in accordance with JIS H3130, with LD set as a bending axis (BadWay bending (B.W. bending)) and bending radius R set as 0.2 mm.

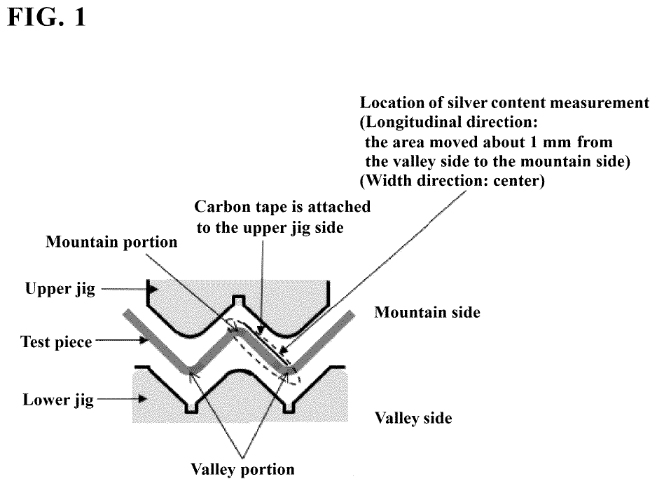

The 90° W bending test will be described with reference to FIG. 1. FIG. 1 is a schematic cross-sectional view illustrating a test piece that is sandwiched between an upper jig and a lower jig to thereby create a mountain portion and a valley portion. When the test piece was sandwiched between the upper jig and the lower jig and bent, the loads applied to the upper and lower jigs were monitored to prevent the upper and lower jigs from applying additional load to the bent test piece.

After this test, carbon tape (Carbon double-sided tape 7322 for SEM: width 12 mm, manufactured by Nisshin EM Co., Ltd.) was attached to the surface of the test piece that had been in contact with the upper jig, and the tape was then manually pulled vertically upward to perform peeling. The carbon tape was attached so that it protruded by 1 mm on both sides in a width direction of the test piece.

For the carbon tape after peeling, observation was performed to a position starting from a center position in the width direction of the test piece corresponding to a bent portion that would become a valley portion and moving 1 mm to a position in a longitudinal direction toward a center position in the width direction of the test piece corresponding to a bent portion that would become a mountain portion on the surface that was in contact with the upper jig of the test piece, using a tabletop electron microscope (TM4000 Plus manufactured by Hitachi High-Technologies Co., Ltd.) at an accelerating voltage of 15 kV and a magnification of 100 times.

Then, an EDS analysis was performed to an observation area (one visual field) of this carbon tape using an energy dispersive X-ray analyzer (AztecOne manufactured by Oxford Instruments Co., Ltd.) attached to the above tabletop microscope. As a result, C, O, Ag, Mo, and S were detected, and the amount of Ag based on the total of these 100 mass % was 0.87 mass %. In this specification, this value is used as an index of the silver shedding during bending.

The above evaluation results are summarized in Table 2 below, together with the evaluation results of Examples 2 to 7 and Comparative Examples 1 and 2, which will be described below.

### Example 2

A composite material was prepared in the same manner as in Example 1, except that the plating time in <Ag-MoS₂ plating> was changed to 510 seconds. The obtained composite material was evaluated in the same manner as in Example 1, for the surface roughness Ra, thickness of the composite coating, crystallite size, content and amount on the surface, of metal sulfide particles, Vickers hardness, coefficient of friction, wear resistance, and silver shedding due to bending. The above evaluation results were summarized in Table 2. Further, in the XRD measurement, the strongest line peak was the peak of the 220 plane.

### Example 3

A composite material was prepared in the same manner as in Example 1, except that the plating time in <Ag-MoS₂ plating> was changed to 3600 seconds. The obtained composite material was evaluated in the same manner as in Example 1, for the surface roughness Ra, thickness of the composite coating, crystallite size, content and amount on the surface, of metal sulfide particles, Vickers hardness, coefficient of friction, wear resistance, and silver shedding due to bending. The above evaluation results were summarized in Table 2. Further, in the XRD measurement, the strongest line peak was the peak of the 220 plane.

### Example 4

A composite material was prepared in the same manner as in Example 1, except that the current density in <Ag-MoS₂ plating> was changed to 3 A/dm² and the plating time was changed to 270 seconds. The obtained composite material was evaluated in the same manner as in Example 1, for surface roughness Ra, thickness of the composite coating, crystallite size, content and amount on the surface, of metal sulfide particles, Vickers hardness, coefficient of friction, wear resistance, and silver shedding due to bending. The above evaluation results were summarized in Table 2. Further, in the XRD measurement, the strongest line peak was the peak of the 220 plane.

### Example 5

A composite material was prepared in the same manner as in Example 1, except that WS₂ particles (WS₂ Powder, average particle size (D50): 5.9 μm (nominal value), manufactured by High purity Chemical Laboratory Co., Ltd.) were used as the metal sulfide particles. The obtained composite material was evaluated in the same manner as in Example 1, for the surface roughness Ra, thickness of the composite coating, crystallite size, content and amount on the surface, of metal sulfide particles, Vickers hardness, coefficient of friction, wear resistance, and silver shedding due to bending.

The above evaluation results were summarized in Table 2. Further, in the XRD measurement, the strongest line peak was the peak of plane 220.

### Example 6

A composite material was prepared in the same manner as in Example 1, except that instead of the sulfonic acid-based silver plating solution of Example 1, a sulfonic acid-based silver plating solution containing methanesulfonic acid at a concentration of 60 g/L as a complexing agent and having a silver concentration of 30 g/L (Dain Silver GPE-PL (containing no compound corresponding to general formula (1) and using water as a solvent) manufactured by Daiwa Kasei Co., Ltd.) was used, to which MoS₂ particles similar to those in Example 1 were added, and the resulting sulfonic acid-based silver plating solution containing metal sulfide particles was used. The obtained composite material was evaluated in the same manner as in Example 1, for the surface roughness Ra, thickness of the composite coating, crystallite size, content and amount on the surface, of metal sulfide particles, Vickers hardness, coefficient of friction, wear resistance, and silver shedding due to bending. The above evaluation results were summarized in Table 2 below. Further, in the XRD measurement, the strongest line peak was the peak of the 111 plane.

### Example 7

A composite material was prepared in the same manner as in Example 4, except that the MoS₂ particles subjected to a basification treatment as described below, were used in Example 4 as the MoS₂ particles in <Ag-MoS₂ plating>.

### <Basification Treatment>

The MoS₂ particles were subjected to a basification treatment before being immersed in a sulfonic acid-based silver plating solution. For the method of the basification treatment, a liquid in which 100 g of MoS₂ particles were added to 1.75 L of pure water was stirred at 400 rpm using a hot stirrer and a strong stirring device, and a temperature was raised to about 50° C. Thereafter, an aqueous solution containing 5 g of KOH was added to the pure water containing the MoS₂ particles to make a volume 2 L, and the mixture was held being stirred for 5 minutes. The pH of the resulting mixture was less than 12. To this mixture, an aqueous solution in which 1 g of KOH was dissolved in 0.05 L of pure water was added, and the mixture was held being stirred for 5 minutes in the same manner as above, followed by measuring pH. This process was repeated until the pH of the mixture reached 12 or more. When the pH reached 12 or more, the mixture was filtered using a suction filter, and a residue was added with pure water, stirred, and filtered, and this process was repeated until the electrical conductivity of the filtrate reached 10 μS/cm or less. When the electrical conductivity of the filtrate reached 10 μS/cm or less, the filtered residue MoS₂ was added to the sulfonic acid-based silver plating solution.

The composite material obtained in this Example 7 was evaluated in the same manner as in Example 1, for the surface roughness Ra, thickness of the composite coating, crystallite size, content and amount on the surface, of metal sulfide particles, Vickers hardness, coefficient of friction and wear resistance, and silver shedding due to bending. For the wear resistance, exposure of the base material after 10,000 sliding cycles was also checked. The above evaluation results were summarized in Table 2. Further, in the XRD measurement, the strongest line peak was the peak of the 220 plane.

### Comparative Example 1

A composite material was prepared in the same manner as in Example 1, except that instead of the metal sulfide particles, flaky graphite particles (PAG-3000, manufactured by Nippon Graphite Industries Co., Ltd.) having an average particle size of 5.0 μm were used after oxidation treatment, and the graphite particles were added to the sulfonic acid-based silver plating solution (Dain Silver GPE-HB, manufactured by Daiwa Kasei Co., Ltd.) used in Example 1 in an amount achieving the concentration of 50 g/L, and in the <Ag-MoS₂ plating>, the sulfonic acid-based silver plating solution containing carbon particles obtained above was used, and the current density was changed to 3 A/dm² and the plating time was changed to 1000 seconds. The average particle size is a particle size at a volume-based cumulative value of 50% measured using a laser diffraction/scattering particle size distribution analyzer (MT3300 (LOW-WET MT3000II Mode) manufactured by Microtrack Bell Co., Ltd.).

The oxidation treatment is as follows. 80 g of the above flaky graphite particles were added to 1.4 L of pure water, and the mixture was heated to 50° C. while stirring. Next, 0.6 L of 0.1 mol/L aqueous potassium persulfate solution was slowly dropped into this mixture as an oxidizing agent, and the mixture was stirred for 2 hours to perform an oxidation treatment. Thereafter, the mixture was filtered using filter paper, and the obtained solid matter was washed with water.

The obtained composite material was evaluated in the same manner as in Example 1, for the surface roughness Ra, thickness of the composite coating, crystallite size, content and amount on the surface, of carbon particles, Vickers hardness, coefficient of friction, wear resistance, and silver shedding due to bending. The evaluation results were summarized in Table 2 below. Further, in the XRD measurement, the strongest line peak was the peak of the 111 plane.

### Comparative Example 2

A composite material was prepared in the same manner as in Comparative Example 1, except that instead of the sulfonic acid-based silver plating solution of Example 1, a sulfonic acid-based silver plating solution containing methanesulfonic acid at a concentration of 60 g/L as a complexing agent and having a silver concentration of 30 g/L (Dain Silver GPE-PL (containing no compound corresponding to general formula (1) and using water as A solvent) manufactured by Daiwa Kasei Co., Ltd.) was used, and graphite particles obtained by subjecting flaky graphite particles (UTC-48J, manufactured by Nippon Graphite Industries Co., Ltd.) having a particle size that is a volume-based cumulative value of 50% of 1.8 μm to oxidation treatment in the same manner as in Comparative Example 1 were added thereto to achieve the concentration of 50 g/L, and the obtained sulfonic acid-based silver plating solution containing carbon particles was used for the <Ag-MoS₂ plating>, with the plating time set as 270 seconds.

The obtained composite material was evaluated in the same manner as in Example 1, for the surface roughness Ra, thickness of the composite coating, crystallite size, content and amount of carbon particles on the surface, Vickers hardness, coefficient of friction, wear resistance, and silver shedding due to bending. The above evaluation results were summarized in Table 2. Further, in the XRD measurement, the strongest line peak was the peak of the 111 plane.

The manufacturing conditions, etc., for the composite materials of Examples 1 to 7 and Comparative Examples 1 and 2 are summarized in Table 1 below, and the evaluation results are summarized in Table 2 below.

TABLE 1

| | | | Example | Example | Example | Example | Example | Example | Example | Com.Ex. | Com.Ex. |
|---|---|---|---|---|---|---|---|---|---|---|---|
| | | | 1 | 2 | 3 | 4 | 5 | 6 | 7 | 1 | 2 |
| Strike | Main | Silver ion (g/L) | 3 | 3 | 3 | 3 | 3 | 3 | 3 | 3 | 3 |
| plating | components | Methane sulfonic | 42 | 42 | 42 | 42 | 42 | 42 | 42 | 42 | 42 |
| | of plating | acid (g/L) | | | | | | | | | |
| | solution | | | | | | | | | | |
| | Current density (A/dm²) | | 5 | 5 | 5 | 5 | 5 | 5 | 5 | 5 | 5 |
| | Plating temperature (° C.) | | 25 | 25 | 25 | 25 | 25 | 25 | 25 | 25 | 25 |
| | Plating time (second) | | 90 | 90 | 90 | 90 | 90 | 90 | 90 | 90 | 90 |
| Ag-based | Main | Silver ion (g/L) | 30 | 30 | 30 | 30 | 30 | 30 | 30 | 30 | 30 |
| plating | components | Presence of absence | present | present | present | present | present | absent | present | present | absent |
| | of | of compound A | | | | | | | | | |
| | plating | Methane sulfonic acid | 60 | 60 | 60 | 60 | 60 | 60 | 60 | 60 | 60 |
| | solution | Types of | MoS2 | MoS2 | MoS2 | MoS2 | MoS2 | MoS2 | MoS2 | C | C |
| | | solid lubricant particles | | | | | | | | | |
| | | Basification/oxidation of | * | * | * | * | * | * | with | with | with |
| | | solid lubricant particles | | | | | | | basification | oxidation | oxidation |
| | | Average particle size of | 5.0 | 5.0 | 5.0 | 5.0 | 5.9 | 5.0 | 5.0 | 5.0 | 1.8 |
| | | solid lubricant particles | | | | | | | | | |
| | | Concentration of | 100 | 100 | 100 | 100 | 100 | 100 | 100 | 50 | 50 |
| | | solid lubricant | | | | | | | | | |
| | | particles (g/L) | | | | | | | | | |

| | | | | | | | | | |
|---|---|---|---|---|---|---|---|---|---|
| Current density (A/dm²) | 1 | 1 | 1 | 3 | 1 | 1 | 3 | 3 | 3 |
| Plating temperature (° C.) | 25 | 25 | 25 | 25 | 25 | 25 | 25 | 25 | 25 |
| Plating time (second) | 855 | 510 | 3600 | 270 | 855 | 855 | 270 | 1000 | 270 |

Note:
Com.Ex. = Comparative Example
*= without basification and oxidation

TABLE 2

| | | Example | Example | Example | Example | Example | Example | Example | Com.Ex. | Com.Ex. |
|---|---|---|---|---|---|---|---|---|---|---|
| | | 1 | 2 | 3 | 4 | 5 | 6 | 7 | 1 | 2 |
| Film thickness (μm) | | 5.1 | 3.0 | 20.9 | 5.7 | 5.0 | 5.5 | 5.3 | 19.8 | 5.0 |
| Ra (μm) | | 0.3 | 0.2 | 2.0 | 0.4 | 0.4 | 0.6 | 0.2 | 3.0 | 0.4 |
| Ra/Film thickness | | 0.059 | 0.067 | 0.096 | 0.070 | 0.080 | 0.109 | 0.038 | 0.152 | 0.080 |
| Crystallite size (nm) | | 51.6 | 60.2 | 50.7 | 54.6 | 59.8 | 69.7 | 17.5 | 15.4 | 64.7 |
| Type of particles | | MoS₂ | MoS₂ | MoS₂ | MoS₂ | WS₂ | MoS₂ | MoS₂ | C | C |
| Content of particles in | | 2.7 | 1.5 | 3.4 | 2.4 | 4.4 | 2.6 | 2.8 | 1.7 | 0.9 |
| composite coating (wt. %) | | | | | | | | | | |
| Amount of particles on | | 9.2 | 7.7 | 13.6 | 9.8 | 20.9 | 7.4 | 5.2 | 12.6 | 10.3 |
| composite coating surface (wt. %) | | | | | | | | | | |
| Vickers hardness (HV) | | 146 | 146 | 146 | 146 | 112 | 66 | 165 | 160 | 70 |
| Coefficient of friction | | 0.21 | 0.2 | 0.22 | 0.21 | 0.26 | 0.21 | 0.13 | 0.24 | 0.26 |
| Wear | Exposure of the base material | No | No | No | No | No | No | No | No | With |
| resistance | after 1000 cycles | exposure | exposure | exposure | exposure | exposure | exposure | exposure | exposure | exposure |
| | Exposure of the base material | No | With | No | No | No | With | No | No | — |
| | after 2500 cycles | exposure | exposure | exposure | exposure | exposure | exposure | exposure | exposure | |
| | Exposure of the base material | — | — | — | — | — | — | No | — | — |
| | after 10000 cycles | | | | | | | exposure | | |
| | the number of reciprocal cycles | 1175 | 709 | 1059 | 696 | 789 | 367 | 2217 | 2890 | 110 |
| | required for decreasing | | | | | | | | | |
| | the thickness by 1 μm | | | | | | | | | |

| | | | | | | | | | |
|---|---|---|---|---|---|---|---|---|---|
| Ag shedding index value (wt. %) | 0.87 | 1.24 | 7.45 | 1.14 | 0.53 | 0.22 | 2.2 | 66 | 0.1 |

Note:
Com.Ex. = Comparative Example

1. A composite material having a composite coating on a base material, the composite coating being composed of a silver layer containing metal sulfide particles, wherein a value X obtained by dividing arithmetic mean roughness Ra (μm) of the composite coating by a thickness (μm) of the composite coating is 0.14 or less.

2. The composite material according to claim 1, wherein metal sulfide constituting the metal sulfide particles is at least one selected from the group consisting of molybdenum sulfide, tungsten sulfide, and tin sulfide.

3. The composite material according to claim 1, wherein a crystallite size of silver in the composite coating is 62 nm or less.

4. The composite material according to claim 1, wherein a mass ratio of the metal sulfide particles on a surface of the composite coating, which is obtained by measuring the surface of the composite coating by energy dispersive X-ray analysis, is 1 to 50 mass %.

5. The composite material according to claim 1, wherein the base material is composed of copper or a copper alloy.

6. The composite material according to claim 1, wherein the metal sulfide constituting the metal sulfide particles is at least one selected from the group consisting of MoS₂ and WS₂.

7. The composite material according to claim 1, wherein a thickness of the composite coating is 0.5 to 45 μm.

8. The composite material according to claim 1, wherein a content of the metal sulfide particles in the composite coating is 0.5 to 30 mass %.

9. The composite material according to claim 1, wherein a crystallite size of silver in the composite coating is 62 nm or less, and the value X is 0.088 or less.

10. The composite material according to claim 1, wherein a content of the metal sulfide particles in the composite coating is 2.5 to 10 mass %, and the metal sulfide constituting the metal sulfide particles is molybdenum sulfide.

11. A composite material manufacturing method comprising: performing electroplating in a silver plating solution containing metal sulfide particles, thereby forming a composite coating on a base material, the composite coating being composed of a silver layer containing the metal sulfide particles.

12. The composite material manufacturing method according to claim 11, wherein the base material is composed of copper or a copper alloy.

13. The composite material manufacturing method according to claim 11, wherein the silver plating solution contains compound A represented by the following general formula (I): 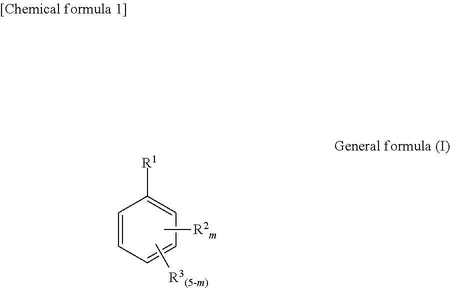
(In formula (I), m is an integer of 1 to 5; R¹ is a carboxyl group; R² is an aldehyde group, a carboxyl group, an amino group, a hydroxyl group, or a sulfonic acid group; R³ is hydrogen or an arbitrary substituent, when m is 2 or more, multiple R²'s may be the same or different from each other, and when m is 3 or less, multiple R³'s may be the same or different from each other, and R¹ and R² may each independently be bonded to a benzene ring via a divalent group constituted by at least one selected from the group consisting of —O— and —CH₂—).

14. The composite material manufacturing method according to claim 11, wherein the metal sulfide constituting the metal sulfide particles is at least one selected from the group consisting of molybdenum sulfide, tungsten sulfide, and tin sulfide.

15. The composite material manufacturing method according to claim 11, wherein the metal sulfide particles have a volume-based cumulative 50% particle size (D50) of 0.5 to 15 μm as measured by a laser diffraction/scattering particle size distribution analyzer.

16. The composite material manufacturing method according to claim 11, wherein the metal sulfide constituting the metal sulfide particles is at least one selected from the group consisting of MoS₂ and WS₂.

17. A terminal in which the composite material according to claim 1 is used as a constituent material thereof.

18. A terminal manufacturing method comprising: processing the composite material according to claim 1 into a shape of a terminal.
